(19) United States
(12) Patent Application Publication
(10) Pub. No.: US 2014/0318317 A1
(43) Pub. Date: Oct. 30, 2014

(54) SYSTEMS AND METHODS FOR EXTRACTING PRECIOUS METAL FROM FOULED CARBON

(71) Applicant: The Vault Corporation, Dayton, NV (US)

(72) Inventors: Hank Chapman, JR., Wells, NV (US); Rick Allen, Mound House, NV (US)

(73) Assignee: The Vault Corporation, Dayton, NV (US)

(21) Appl. No.: 14/216,178

(22) Filed: Mar. 17, 2014

Related U.S. Application Data
(60) Provisional application No. 61/800,648, filed on Mar. 15, 2013.

(51) Int. Cl. C22B 11/00; C22B 1/02; F27D 21/00; F27D 7/04; F27D 5/00; F27D 19/00

(52) U.S. Cl. CPC C22B 11/00; F27D 5/00; F27D 19/00; F27D 21/0014; F27D 7/04; C22B 1/02
USPC 75/330; 432/253; 432/203; 432/72; 432/37; 29/428

(57) ABSTRACT

A system for ashing carbon includes a vertically oriented burner column having a first end and an opposing end with an interior chamber therebetween. The burner column has an aperture at the first end and a suction port proximal to the second end, the aperture and the suction port in communication with the interior chamber. The system also comprises a porous media screen located in the interior chamber and positioned between the first end and the second end of the burner column. The media screen is adapted to hold ignited carbon containing a precious metal therein. The system also contains a pump that is coupled to the suction port. The pump is configured to apply a negative pressure to the interior chamber of the burner column to draw air into the interior chamber via the aperture. The drawn air passes through the ignited carbon at a desired flow rate to achieve a temperature of the carbon suitable for ashing the carbon.

The present application claims the benefit of U.S. Provisional Patent Application Ser. No. 61/800,648, filed on Mar. 15, 2013, which is hereby incorporated by reference in its entirety.

### FIELD

The present disclosure is directed to the field of precious metal recovery and in particular, a system and method for extracting precious metal from carbon.

### BACKGROUND

### Using Carbon in Gold Production

Carbon is an important component that is used in modern mining and in particular the recovery of precious metals from mined carbon. Carbon that is used in mining operations is often referred to as activated carbon or charcoal. Such carbon is typically created by grinding coconut shells and burning the product in a controlled low oxygen reduction atmosphere. Such carbon is typically attrited before it is used in precious metal recovery operations. Attrition of the carbon encompasses gently agitating the carbon for several hours to remove dust and loose surface particles, thereby leaving the coarse portions of the carbon.

Carbon is used in two types of leach circuits to recover gold which has been liberated into a cyanide solution as part of the gold cyanidation process. The first type of leach circuit is the CIP (carbon in pulp) or CIL (carbon in leach) circuit, which, for the purpose of this disclosure are considered the same. During the gold cyanidation process, ore containing gold is comminuted and mixed with water to produce a slurry. The slurry is combined with a solution of cyanide (e.g., sodium cyanide or potassium cyanide) to convert the gold into a water soluble coordination complex. Carbon is introduced into the slurry, in a process called countercurrent decantation to adsorb the gold cyanide complex (AuCN). Because the cyanide has a weaker affinity for the gold molecule, than the carbon (i.e., ionic vs. covalent bond), the carbon takes the gold molecule and releases the cyanide molecule back to the solution to be used again. After countercurrent decantation, the carbon is rinsed to remove most of the slurry, stripped in the strip circuit, and regenerated before being returned to the leach circuit.

The other type of leach circuit is the classic heap leach. In a heap leach, mined, crushed ore is placed on a carefully contoured piece of Hypalon or other durable liner. The ore is stacked with feeder tubes installed at regular intervals (layered) or sprinklers to supply the cyanide solution to the ore. The cyanide solution filters through the heap, adsorbing the gold as it passes through. The leach solution filters down through the pad, collects on the liner and goes to the “preg” (pregnant) pond. The solution may be re-circulated to the heap, but is generally pumped through cascading columns of carbon to be stripped. In this process, the leach solution enters the column from the bottom and gently lifts and agitates the carbon. The carbon columns are rotated by utilizing a manifold. The solution is pumped through the highest loaded column first, an intermediate loaded column, and finally the least loaded column. The loaded carbon is removed when appropriate values are present, stripped, and regenerated.

After loading activated carbon with gold in one of the above described circuits, gold recovery proceeds by elution or stripping of the carbon, carbon regeneration, and gold production by electrowinning or cementation from the eluated solution.

Carbon comes in three different activity levels, i.e., low, medium, and high activity levels. Medium activity carbon is currently the preferred carbon used in mining. This carbon will load (adsorb) around 400-500 Oz/Ton of precious metals, and can be stripped utilizing either atmospheric strip (Zadra strip) or pressure strip. While high activity carbon will load in the 800-1000 Oz/Ton range with gold, it will not strip to acceptable levels using any known non-destructive stripping method. Accordingly, it would be desirable to develop an economical and non-hazardous method for recovering the precious metals from high activity carbon.

### Fouled Carbon

In each of the above described leaching methods, precious metals are not the only elements that are put in solution. Iron, arsenic, antimony, lead, copper, mercury, silver, chloroplatinates, and numerous other elements are put in solution and loaded on the carbon to a greater or lesser degree. The more base metals that are adsorbed on the carbon, the more precious metals are displaced.

Ultimately, after four or five loading, striping and regenerating cycles, the carbon becomes fouled, i.e., soluble silicates in the water, as well as calcium, sodium, potassium and other hard water elements have blinded the carbon pore structure.

The fouled carbon carries residual precious metal values as well as the trash elements and toxic elements such as mercury or arsenic. The precious metal values in fouled carbon usually run from 4 Oz/Ton of gold to as high as 24 Oz/Ton of gold, depending on the efficiency and duration of the strip circuit.

One method for recovering residual precious metals from the fouled carbon is to apply the cold, fouled carbon to a hot, very strong caustic and cyanide solution. This “shocks” the carbon and allows recovery of some, but not all, of the residual values.

The only means to achieve total recovery of residual values of precious metals from fouled carbon is through destruction of the carbon. The issue, of course, is that fouled carbon is a toxic hazardous waste. Therefore, it is desirable to develop a safe, non-toxic method for recovering precious metals from fouled carbon.

This technology is directed at overcoming these and other deficiencies in the art.

### SUMMARY

An example of a system for ashing carbon includes a vertically oriented burner column having a first end and an opposing end with an interior chamber therebetween. The burner column has an aperture at the first end and a suction port proximal to the second end, the aperture and the suction port in communication with the interior chamber. The system also comprises a porous media screen located in the interior chamber and positioned between the first end and the second end of the burner column. The media screen is adapted to hold ignited carbon containing a precious metal therein. The system also contains a pump that is coupled to the suction port. The pump is configured to apply a negative pressure to the interior chamber of the burner column to draw air into the interior chamber via the aperture. The drawn air passes through the ignited carbon at a desired flow rate to achieve a temperature of the carbon suitable for ashing the carbon.

An example of a method for ashing carbon involves loading carbon onto a porous media screen of a vertically oriented burner column. The burner column has a first end and an opposing end and an interior chamber therebetween. The burner column also has an aperture at the first end and a suction port proximal to the second end, the aperture and the suction port in communication with the interior chamber. The porous media screen is located in the interior chamber and positioned between the first end and the second end of the burner column. This method further involves igniting the loaded carbon, and applying negative pressure to the interior chamber of the burner column using a pump. The pump is coupled to the suction port of the burner column and the negative pressure generated by the pump draws air into the interior chamber via the aperture and through the ignited carbon on the porous media screen at a desired flow rate to achieve a temperature of the carbon suitable for ashing the ignited carbon.

Another aspect of the technology is directed to a method for assembling a system suitable for ashing carbon. This method involves providing a vertically oriented burner column having a first end and a opposing end and an interior chamber therebetween, the burner column having an aperture at the first end and a suction port proximal to the second end, the aperture and the suction port in communication with the interior chamber, and a porous media screen adapted to hold ignited carbon that is located in the interior chamber and positioned between the first end and the second end of the burner column; and coupling a pump to the suction port of the burner column, the pump configured to apply a negative pressure to the interior chamber of the burner column to draw air into the interior chamber via the aperture and through the ignited carbon on the porous media screen at a desired flow rate to achieve a temperature of the carbon suitable for ashing the carbon.

As noted above, there is a need in the art to develop an economical and non-hazardous method for recovering precious metals from various forms of carbon, including high activity carbon and fouled carbon. Accordingly, this technology is directed to a system and method for burning carbon, e.g., stripped, loaded, or fouled carbon, into an ash or substantially ashed form while maintaining control over hazardous vapor steam that is generated as a byproduct of the burning carbon. The system is self-fueling, as the carbon is capable of producing the requisite amount of heat to create carbon ash. In addition, the system and method for this technology is capable of recovering fly ash containing precious metals that is produced during the ashing process, thereby maximizing precious metal recovery.

### BRIEF DESCRIPTION OF THE DRAWINGS

The accompanying drawings, which are incorporated into and constitute a part of this specification, illustrate one or more aspects of the present disclosure which along with the detailed description and claims, serve to explain the principles and implementations of one or more examples of the present system and method.

FIG. 1 is a schematic overview of an example of a system for ashing carbon.

FIGS. 2A-2B are side and front views, respectively, of an example of a burner column used in the system for ashing carbon.

FIG. 3 is a side view of an example of a burner column used in the system for ashing carbon.

FIG. 4 is schematic of the air flow through an example of the pump component of the system for ashing carbon

FIG. 5 is a schematic showing an example of the burner column or burning column of the system coupled to a condenser unit and contaminant trap.

### DETAILED DESCRIPTION

A first aspect of this technology is directed to a system for ashing carbon. This system comprises a vertically oriented burner column having a first end and an opposing end with an interior chamber therebetween. The burner column has an aperture at the first end and a suction port proximal to the second end, the aperture and the suction port in communication with the interior chamber. The system also comprises a porous media screen located in the interior chamber and positioned between the first end and the second end of the burner column. The media screen is adapted to hold ignited carbon containing a precious metal therein. The system also contains a pump that is coupled to the suction port. The pump is configured to apply a negative pressure to the interior chamber of the burner column to draw air into the interior chamber via the aperture. The drawn air passes through the ignited carbon at a desired flow rate to achieve a temperature of the carbon suitable for ashing the carbon.

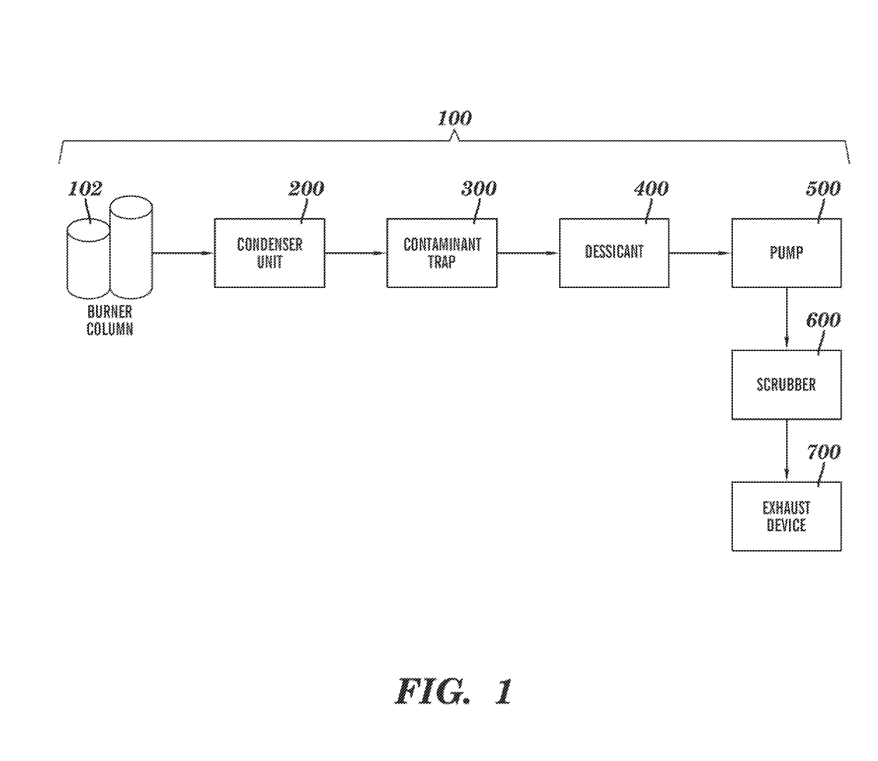

FIG. 1 is a schematic overview of an exemplary system 100 to ash carbon for extraction of precious metals in accordance with an aspect of the present disclosure. In particular, the system 100 is configured to provide enough free oxygen for carbon to burn into an ash or substantially ashed form. The system is further configured to maintain control over hazardous vapor that is generated as a byproduct of the burning carbon, in particular fouled carbon. Additionally, the system is configured to recover fly ash that may escape during the burning of the carbon as the fly ash may contain a meaningful amount of precious metals.

The exemplary system 100 shown in FIG. 1 includes one or more burner columns 102 where the carbon is burned to ash. The one or more burner columns are coupled either directly or via a manifold to a condenser unit 200, contaminant trap 300, and a desiccant trap 400, which collectively function to remove one or more hazardous contaminants and excess moisture from the vapor stream generated as a byproduct of the ashing process. The desiccant trap 400 is connected to the pump 500 of the system 100. The pump 500 applies a negative pressure to the interior chamber of the burner column to generate the airflow through the burner column necessary to burn the carbon. The negative pressure of the pump 500 further pulls the vapor stream generated from the burning carbon through the condenser unit 200, contaminant trap 300, and desiccant chamber 400. The pump 500 can be a regenerative compressor capable of receiving the vapor stream from the burner column 102 and pushing it out to one or more scrubber units 600 for further filtering and removal of hazardous components. The scrubber unit 600 is coupled to an exhaust device 700.

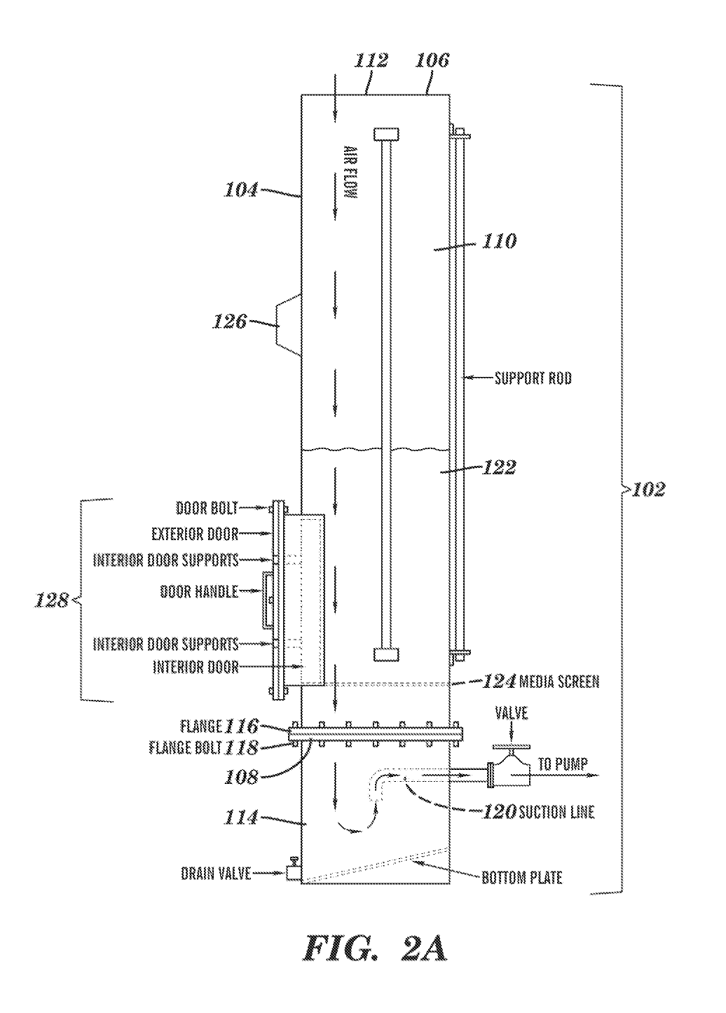

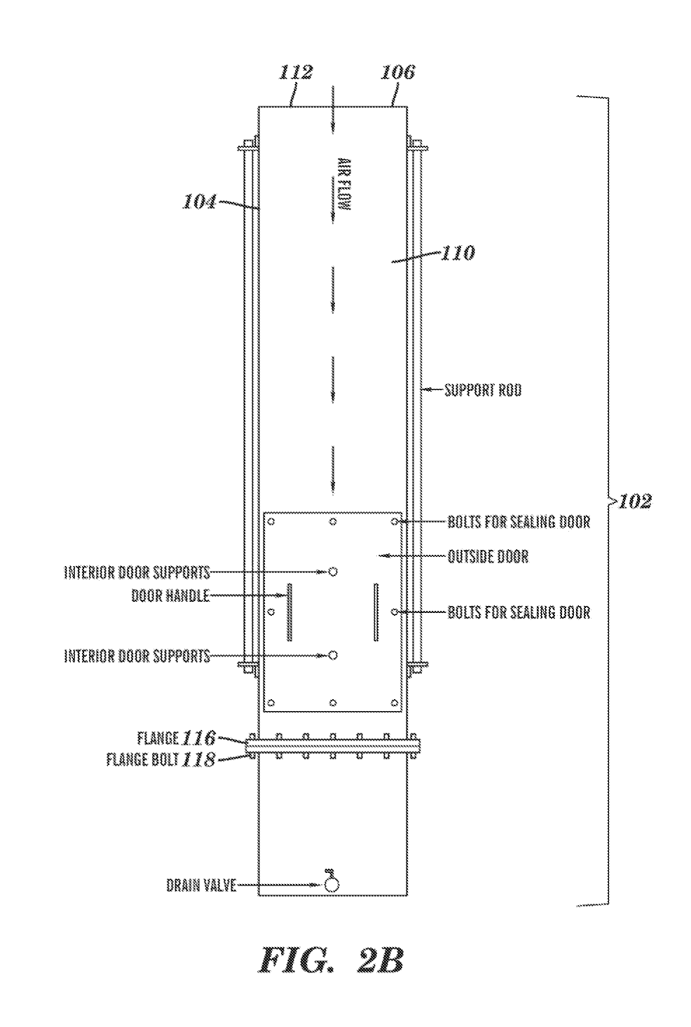

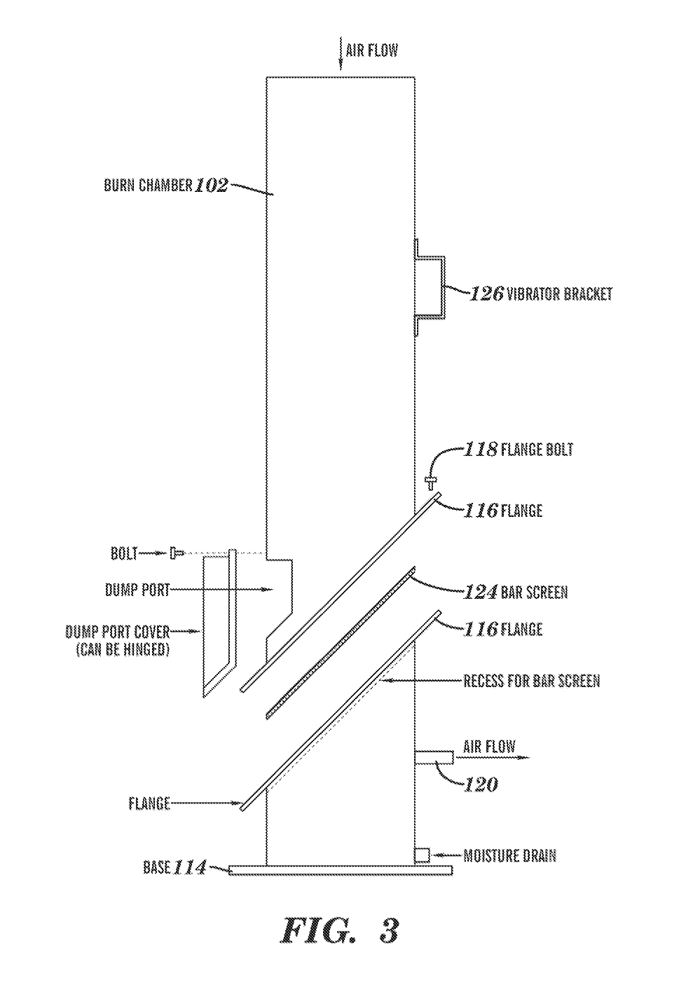

FIGS. 2A and 2B illustrate an example burner column 102 in accordance with an aspect of the present disclosure. As shown in FIG. 2A, the burner column 102 has a vertically oriented cylindrical body 104 with a top 106 and a bottom 108. The body 104 has a hollow interior chamber 110 which is configured to hold carbon 122, for example, fouled carbon that is ignited and burned to produce carbon ash. The body of the burner column 102 also comprises a door 128 providing access to the interior chamber 110 of the burner column 102 and a means to load carbon and retrieve ashed carbon.

The system of this technology may comprise one or more burner columns. When two or more burner columns are employed in the system, the each burner column 102 is connected via its suction port 120 to a manifold. The manifold connects the one or more burner columns to the downstream components of the system (e.g., the condenser, pump, etc.).

The top 106 of the burner column 102 has an aperture 112 that is in communication with the interior chamber 110 and outside air. In particular, outside air is drawn into and through the chamber 110 through the aperture 112 as a means of burning the carbon 122 at a desired temperature, i.e., the airflow controls the burn rate and temperature of the ignited carbon 122 within the burner column.

As shown in FIGS. 2A and 2B, in one aspect of this technology, the bottom 108 of the burner column body 104 is coupled to a base 114 using a flange 116 and flange bolts 118. It should be noted that, in other aspects of this technology, the body 104 and the base 114 may be coupled together by other means. In another aspect of this technology, the burner column 102 may be configured to integrally employ the base 114 and the body 104 so that the burner 102 is a single unit.

The base 114 of the burner column 102 is configured to be in communication with the interior chamber 110 of the body 104. The burner 102 contains a permeable barrier element or porous media screen 124 positioned in the chamber 110 near the bottom 108. The permeable screen is configured to hold the ignited carbon 122 in the chamber 110 while allowing air that is entering through the aperture 112 to flow through the carbon and exit via the suction port 120. In one aspect, the porous screen 124 is a high grade stainless steel mesh screen.

The mesh size of the porous screen is suitable for retaining large clinkers and unburned carbon and allowing carbon ash to pass through, i.e., typically the mesh size is between −10 and −20, more preferably between −12 and −18, most preferably −16. The carbon ash is collected for precious metal recovery using methods known to those of skill in the art.

The interior chamber 110 of the burner 102 has a known volume that is used in conjunction with the amount of carbon in the chamber 110 and the amount of negative pressure applied by the pump 500 to ensure that the carbon is at a desired temperature and/or exhibits a desired burn rate and/or burn time.

Suitable materials for constructing a burner column or burner column of this technology include, without limitation black iron. The interior walls of the burner column are coated with a material that will prevent moist carbon from sticking to it. Suitable coatings are well know to those of skill in the art and may include, for e.g., Slip Plate®. Other means for keeping the interior walls of the burner column free from moist carbon include the use of a vibrating element 126, e.g., a hopper vibrator. In one aspect, the hopper vibrator is mounted to the side of the burner column. The vibrating element 126 agitates the carbon in the chamber 110 and ensures that all of the carbon particles are burned. The vibrating element also facilitates settling of the carbon bed. In an aspect, the vibrating element 126 operates on a timer, although it is contemplated that the vibrating element 126 may be electronically controlled by computer based on sensor data.

As indicated above, the base 114 of the burner column is configured to have a suction port 120 that is in communication with the interior of the base 114. The suction port 120 is coupled to a pump 500, such as a regenerative blower, ring compressor, or similar device. In one embodiment, the suction port 120 is coupled to the pump 500 via a valve which is configured to control the air flow through the burner column. The pump 500 is configured to apply a negative pressure or a vacuum via the suction port 120 to the interior chamber 110 of the burner column body 104 to drawn outside air into the body 104 of the burner column 102 through the top aperture 112. The drawn air exits the burner column 102 via the suction port 120 of the base 114. While passing through the burner column 102, the drawn-in air provides a predetermined amount of oxygen to the burning carbon 122 to ensure that the carbon undergoes the ashing process.

As discussed above, the carbon may contain mercury and/or other hazardous materials that are released as a vapor stream when the carbon is burned and it is highly desirable to remove these hazardous materials from the vapor stream. Therefore, in one embodiment, the system of this technology further comprises a condenser unit 200 coupled to a contaminant trap 300. The condenser unit 200 and contaminant trap 300 are positioned between the burner column 102 and the pump 500 such that the negative pressure applied by the pump 500 draws the vapor stream generated from the ignited carbon out of the interior of the burner column 102 via the suction port 120 and through the condenser 200 and trap 300.

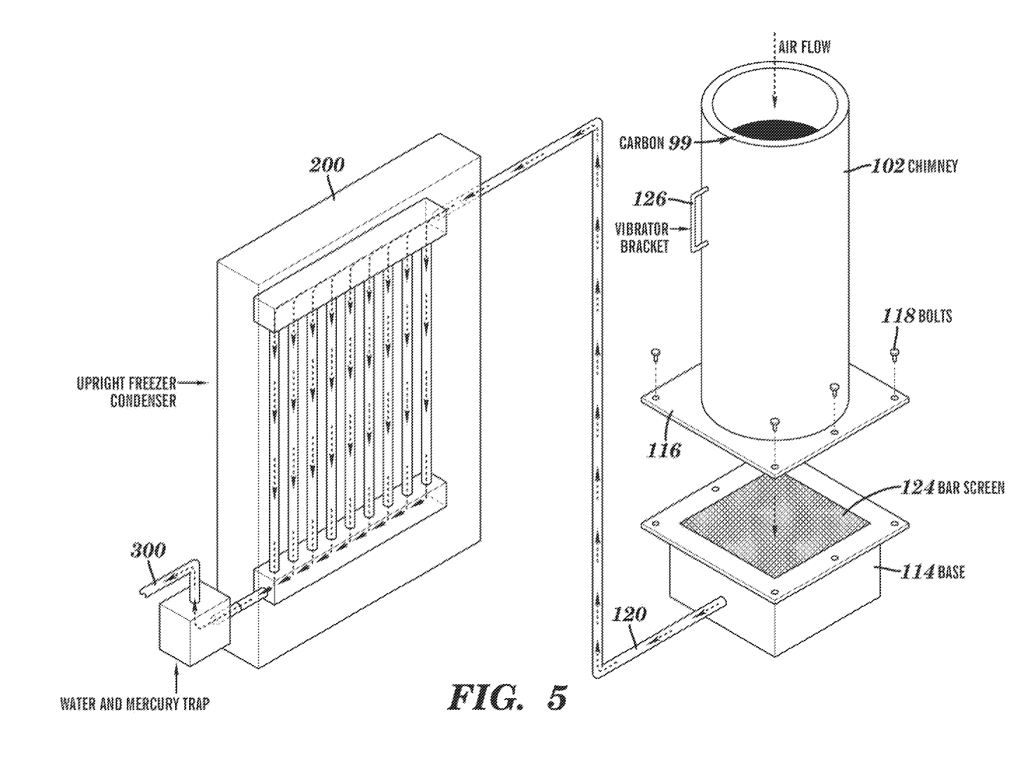

The condenser unit 200 functions to quickly reduce the temperature of the vapor stream to facilitate the precipitation and removal of one or more hazardous materials from the stream. For example, in the case of mercury, the vapor stream must be cooled to a temperature below 70° C. to precipitate the mercury vapor as metallic, recoverable mercury. FIG. 5 is a diagram showing integration of a condenser 200 and a mercury trap 300 into the system of this technology. The condenser unit 200 shown in this Figure is an upright freezer unit which facilitates an ‘in-the-top, out-the-bottom’ flow through of the vapor stream into the contaminant trap 300. Commercially available condensers in a variety of designs and sizes are suitable for use in the system of this technology. A thermometer mounted through the door or side of the condenser unit 200 allows the monitoring of interior temperature.

A containment trap 300 is coupled to the condenser unit 200 to trap one or more hazardous precipitates from the vapor stream after it exits the condenser unit 200. Commercially available contaminant traps are suitable for use in the system of this technology (see e.g., Valco Instruments Co, Inc., Apex Instruments). The contaminant trap may further comprise or be coupled to a contaminant analyzer (also known as a “sniffer”) that monitors the levels of particular contaminants or chemicals in the vapor stream. Contaminant analyzers that are suitable for use in the system of this technology are commercially available, see e.g., On-Site Instruments, LLC, and Ohio Lumex.

While the condenser unit 200 may have the capacity to remove excess moisture, the system of this technology may further employ a desiccant chamber 400 plumbed to the condenser unit 200 or the contaminant trap 300 as shown in FIG. 1 that functions as an additional means for moisture removal. Placing a duct with a small blower around the burner column allows hot air to be blown through the desiccant chamber, allowing it be regenerated as it works. Suitable desiccants are well known in the art, including, for example and without limitation, Drierite™ desiccants.

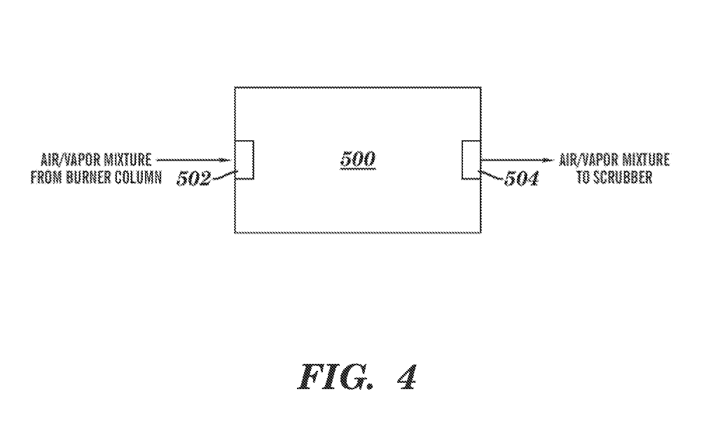

Airflow through the burner column 102, and carbon 122 therein, the condenser unit 200, contaminant trap 300, and the desiccant chamber 400 is facilitated by the negative pressure of the entry port 502 on the pump 500 (FIG. 4). The pump 500 in turn applies positive pressure to the received air/vapor mixture to push the mixture out through the exit port 504 to one or more filters, traps and/or scrubber devices 600. It should be noted that one pump 500 can be coupled to one or more burner columns 102. Suitable pumps include regenerative blowers such as the Rotron® regenerative blowers, or other regenerative blowers designed for chemical processing.

It is also contemplated that pressure applying devices other than a regenerative blower 500 may be employed in the system 100. For example, it is contemplated that two different pressure applying devices may be utilized in the system 100. For instance, a first such pressure applying device can be coupled to the burner 102 to apply negative pressure wherein the first device is coupled to a second device and supplies the received vapor/air mixture to the second device which applies positive pressure to push the air/vapor mixture downstream to the next device in the system 100.

The last item on the positive pressure side of the regenerative pump is the wet venturi scrubber 600, which functions to collect both particulate and gaseous pollutants from the vapor stream. In accordance with the system of this technology, the scrubber 600 may include sodium sulfite to revert any metallic oxides or vapors to sulfides that can be recovered, as opposed to discharging into the atmosphere.

The number of burner columns and their size/volume is adjusted for particular system based on the amount of carbon to be ashed in the chamber 110 and the amount of negative pressure applied by the regenerative blower 500 to ensure that the carbon is at a desired temperature and/or exhibits a desired burn rate and/or burn time. In other words, the burn time is predicated on the volume of air pulled through the carbon. In an aspect, one or more sensors are employed to measure the amount of air flow, the temperature of the carbon, the volume of carbon in the chamber 110 and the like. The one or more sensors may be connected to one or more computer devices which utilize the sensor data to continually or periodically adjust the amount of pressure that is applied by the pump 500.

The system of this technology can be used to ash stripped, loaded, or fouled carbon. Regardless of whether stripped, loaded, or fouled carbon is ashed, a stacking approach is employed. “Stacking” entails burning down the first load of carbon, refilling the burner column, and burning the carbon down again. This approach maximizes the values in the ash, giving a very high grade product to work with. The ash is dumped from burner column and screened through −16 mesh. The ash is then suitable for refining and precious metal recovery using methods known to those of skill in the art.

Another aspect of this technology is directed to a method for ashing carbon. An example of a method for ashing carbon involves loading carbon onto a porous media screen of a vertically oriented burner column. The burner column has a first end and an opposing end and an interior chamber therebetween. The burner column also has an aperture at the first end and a suction port proximal to the second end, the aperture and the suction port in communication with the interior chamber. The porous media screen is located in the interior chamber and positioned between the first end and the second end of the burner column. This method further involves igniting the loaded carbon, and applying negative pressure to the interior chamber of the burner column using a pump. The pump is coupled to the suction port of the burner column and the negative pressure generated by the pump draws air into the interior chamber via the aperture and through the ignited carbon on the porous media screen at a desired flow rate to achieve a temperature of the carbon suitable for ashing the ignited carbon.

In accordance with this aspect of this technology, the interior chamber of the burner column and, more specifically, the porous media screen within the burner column is accessed for carbon loading via the door of the burner column. The carbon, i.e., stripped, loaded, or fouled carbon, is loaded on the porous media screen of the burner column and ignited using any suitable means, e.g., a large trigger propane burner. Negative pressure is applied to the interior chamber of the burner column to start the airflow through the ignited carbon in the column (via the aperture). The temperature of the ignited carbon and airflow are continually monitored and adjusted using the appropriate detection systems within the interior chamber of the burner column. The burner column is vibrated periodically throughout the ashing process, e.g., 5-10 minutes per hour, to continually settle the bed of carbon and achieve uniform burning.

The vapor stream generated from the ignited carbon is pumped out of the burner column and preferably through a condenser unit for cooling and a contaminant trap to remove at least one precipitated toxicant from the cooled vapor stream. The vapor stream can further be pumped through one or more additional filters or scrubbers to remove other particulate and/or gaseous pollutants from the stream. The vapor stream exiting the burner column is preferably monitored for the presence of one or more hazardous components using one or more detector systems employed within the system. In one embodiment, the system comprises a contaminant analyzer that is downstream of the contaminant trap and/or other filter units.

Once the carbon has been ashed, it is removed from the burner column and screened using a fine mesh material to exclude large clinkers or unburned carbon particles. The screened ash is then suitable for precious metal recovery using methods known to those of skill in the art.

This method involves providing a vertically oriented burner column having a first end and a opposing end and an interior chamber therebetween, the burner column having an aperture at the first end and a suction port proximal to the second end, the aperture and the suction port in communication with the interior chamber, and a porous media screen adapted to hold ignited carbon that is located in the interior chamber and positioned between the first end and the second end of the burner column; and coupling a pump to the suction port of the burner column, the pump configured to apply a negative pressure to the interior chamber of the burner column to draw air into the interior chamber via the aperture and through the ignited carbon on the porous media screen at a desired flow rate to achieve a temperature of the carbon suitable for ashing the carbon.

Example aspects are described herein in the context of a system and method for extracting precious metals from carbon. Those of ordinary skill in the art will realize that the following description is illustrative only and is not intended to be in any way limiting. Other aspects will readily suggest themselves to such skilled persons having the benefit of this disclosure. References are made in detail to implementations of the example aspects as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

1. A system for ashing carbon, the system comprising:
a vertically oriented burner column having a first end and a opposing end and an interior chamber therebetween, the burner column having an aperture at the first end and a suction port proximal to the second end, the aperture and the suction port in communication with the interior chamber;
a porous media screen located in the interior chamber and positioned between the first end and the second end of the burner column, the media screen adapted to hold ignited carbon containing a precious metal therein; and
a pump coupled to the suction port of the burner column, the pump configured to apply a negative pressure to the interior chamber of the burner column to draw air into the interior chamber via the aperture and through the ignited carbon at a desired flow rate to achieve a temperature of the carbon suitable for ashing the carbon.

2. The system of claim 1, wherein the pump comprises an entry port suitable for receiving a vapor stream generated from the ignited carbon in the interior chamber of the burner column and an exit port capable of pumping the received vapor stream out of the pump.

3. The system of claim 1, wherein the pump is a regenerative blower.

4. The system of claim 1, the system further comprising:
a condenser unit located between the burner column and the pump, the condenser unit configured to receive and cool vapor stream that is output from the suction port of the burner column and
one or more contaminant traps coupled to the condenser, the contaminant trap configured to remove at least one precipitated toxicant from the condensed vapor.

5. The system of claim 4, wherein the contaminant trap is a mercury trap and the toxicant is mercury.

6. The system of claim 2 further comprising one or more filters coupled to the exit port of the pump, wherein the filters are configured to receive vapor stream from the pump and capture particulate and/or gaseous pollutants from the vapor stream.

7. The system of claim 1 further comprising a vibrating mechanism coupled to the burner column, wherein the vibrating mechanism causes the ignited carbon to settle on the porous media screen.

8. The system of claim 1 further comprising a control system coupled to the burner column and the pump, the control system comprising:
a temperature sensor configured to monitor the temperature of the ignited carbon on the porous media screen and
a feedback mechanism configured to adjust, in real time, the negative pressure applied by the pump in response to the temperature monitored by the temperature sensor.

9. The system of claim 1 further comprising one or more chemical sensors located between the burner column and the pump, the one or more chemical sensors configured to detect and monitor toxicants in vapor stream generated from the ignited carbon within the interior chamber of the burner column.

10. The system of claim 1, wherein the burner column is a first burner column, the system further comprising:
a second vertically oriented burner column having a first end and an opposing end and an interior chamber therebetween, the second burner column having an aperture at the first end and a suction port proximal to the second end, the aperture and the suction port in communication with the interior chamber;
a porous media screen located in the interior chamber of the second burner column and positioned between the first end and the second end of the second burner column, the media screen adapted to hold ignited carbon containing precious metal therein;
wherein the suction ports of the first and second burner columns are coupled to the pump via a manifold, and the pump is configured to apply the negative pressure in the interior chamber of the first and second burner columns to draw air into the interior chambers via the apertures of each burner column and through the ignited carbon of each burner column at the desired flow rate to achieve the desired temperature of the carbon to suitable for ashing the carbon in each burner column.

11. A method for ashing carbon, the method comprising:
loading carbon onto a porous media screen of a vertically oriented burner column having a first end and an opposing end and an interior chamber therebetween, the burner column having an aperture at the first end and a suction port proximal to the second end, the aperture and the suction port in communication with the interior chamber, wherein said porous media screen is located in the interior chamber and positioned between the first end and the second end of the burner column;
igniting the loaded carbon; and
applying negative pressure to the interior chamber of the burner column using a pump, wherein said pump is coupled to the suction port of the burner column and said negative pressure draws air into the interior chamber of the burner column via the aperture and through the ignited carbon on the porous media screen at a desired flow rate to achieve a temperature of the carbon suitable for ashing the ignited carbon.

12. The method for claim 11, wherein the pump comprises an entry port suitable for receiving a vapor stream generated from the ignited carbon in the interior chamber of the burner column and an exit port capable of pumping the received vapor stream out of the pump.

13. The method for claim 12, wherein the pump is a regenerative blower.

14. The method for claim 11 further comprising:
cooling vapor stream generated by the ignited carbon in a condenser unit that is located between the burner column and the pump and
removing at least one precipitated toxicant from the cooled vapor in one or more contaminant traps coupled to the condenser.

15. The method for claim 14 further comprising:
detecting and monitoring toxicants in the vapor stream after the removing.

16. The method for claim 14, wherein the contaminant trap is a mercury trap and the toxicant is mercury.

17. The method for claim 12 further comprising pumping the received vapor stream into one or more filters coupled to the exit port of the pump under conditions effective to capture particulate and/or gaseous pollutants from the vapor stream in the filter.

18. The method for claim 11 further comprising vibrating the burner column after the applying, wherein the vibrating causes the ignited carbon to settle on the porous media screen.

19. The method for claim 11 further comprising:
monitoring the temperature of the ignited carbon in the burner column and
adjusting the negative pressure applied by the pump based on the monitoring.

20. A method for assembling a system suitable for ashing carbon, the method comprising:
providing a vertically oriented burner column having a first end and a opposing end and an interior chamber therebetween, the burner column having an aperture at the first end and a suction port proximal to the second end, the aperture and the suction port in communication with the interior chamber, and a porous media screen adapted to hold ignited carbon located in the interior chamber and positioned between the first end and the second end of the burner column; and
coupling a pump to the suction port of the burner column, the pump configured to apply a negative pressure to the interior chamber of the burner column to draw air into the interior chamber via the aperture and through ignited carbon loaded on the porous media screen at a desired flow rate to achieve a temperature of the carbon suitable for ashing the carbon.
